(19) United States
(12) Patent Application Publication
(10) Pub. No.: US 2014/0230499 A1
(43) Pub. Date: Aug. 21, 2014

(54) LOCK CONTROL DEVICE, LOCK CONTROL METHOD, AND LOCK CONTROL SYSTEM

(71) Applicants: Masaya TOKORO, Nisshin-shi (JP); Akira OGINO, Toyota-shi (JP)

(72) Inventors: Masaya TOKORO, Nisshin-shi (JP); Akira OGINO, Toyota-shi (JP)

(73) Assignee: TOYOTA JIDOSHA KABUSHIKI KAISHA, Toyota-shi (JP)

(21) Appl. No.: 14/178,868

(22) Filed: Feb. 12, 2014

(30) Foreign Application Priority Data
Feb. 19, 2013 (JP) 2013-029802

(51) Int. Cl. E05B 43/00; E05B 81/00

(52) U.S. Cl. CPC E05B 43/005; E05B 81/00
USPC 70/267

(57) ABSTRACT

A lock control device controls a lid lock that locks a lid of a vehicle, the lid being opened when energy is replenished in the vehicle. The lock control device includes a time measurement part that measures elapsed time from a point when a door lock of the vehicle is switched from an unlocked state to a locked state when the vehicle is stopped, and a lid control part, which maintains the lid lock in an unlocked state until the elapsed time reaches determination time, and switches the lid lock to a locked state once the elapsed time reaches the determination time, when the door lock is switched from the unlocked state to the locked state when the vehicle is stopped.

### INCORPORATION BY REFERENCE

The disclosure of Japanese Patent Application No. 2013-029802 filed on Feb. 19, 2013 including the specification, drawings and abstract is incorporated herein by reference in its entirety.

### BACKGROUND OF THE INVENTION

1. Field of the Invention

The invention relates to a lock control device, a lock control method, and a lock control system, which control a lid lock of a lid of a vehicle, the lead being opened when energy is replenished in the vehicle.

2. Description of Related Art

A lock control system is known, which controls a lid lock for a lid of a vehicle (for example, a charging inlet lid and a fuel lid) that is opened when energy for driving the vehicle (a source of power such as electric energy and gasoline) is replenished. For example, in Japanese Patent Application Publication No. 2005-280586 A (JP 2005-280586 A), an opening and closing device for a fuel lid is described.

To be specific, the opening and closing device for the fuel lid described in JP 2005-280586 A includes a fuel lid unlock driving unit that unlocks the locked fuel lid, and a fuel lid controlling unit that actuates the fuel lid unlock driving unit so that the fuel lid unlock driving unit unlocks the fuel lid. In a case where a vehicle is in a stopping state and a door is an unlocked state, once a second unlocking operation by long pushing is carried out, the fuel lid controlling unit actuates the fuel lid unlock driving unit so that fuel lid unlock driving unit unlocks the fuel lid.

It can be considered that the lid lock is controlled such that the lid lock for the lid of the vehicle is switched to a locked state at the same time as when a door lock of the vehicle is switched into a locked state, and the lid lock is switched to an unlocked state at the same time as when the door lock is switched to an unlocked state. In this case, when energy is replenished in the vehicle, it is assumed that a user of the vehicle carries out a door locking operation immediately after the user disembarks from the vehicle so as not to forget to carry out the door locking operation after energy is replenished. However, if the user carries out the door locking operation immediately after disembarkation from the vehicle, not only the door lock but also the lid lock are switched to the locked state. Therefore, in order to open the lid, the user needs to perform the door unlocking operation for switching the door lock to the unlocked state. Thus, the user is required to operate the door lock twice when replenishing energy in the vehicle, which is troublesome for the user. On the contrary, when the user does not perform the door locking operation immediately after disembarkation from the vehicle, there is a possibility that the user forgets to perform the door locking operation after energy is replenished.

### SUMMARY OF THE INVENTION

The present invention enhances convenience for a vehicle user with a lock control system and control method, which control a lock of a lid in a vehicle, the lid being opened when energy is replenished.

A lock control device according to a first aspect of the present invention, which controls a lid lock that locks locking a lid of a vehicle, the lid being opened when energy is replenished in the vehicle, includes a time measurement part that measures elapsed time from a point when a door lock of the vehicle is switched from an unlocked state to a locked state when the vehicle is stopped, and a lid control part, which maintains the lid lock in an unlocked state until the elapsed time reaches determination time, and switches the lid lock to a locked state when the elapsed time reaches the determination time, in a case where the door lock is switched from the unlocked state to the locked state when the vehicle is stopped.

A lock control method according to a second aspect of the present invention controls a lid lock of a lid of a vehicle, the lid being opened when energy is replenished in the vehicle. The lock control method includes measuring elapsed time from a point when a door lock of the vehicle is switched to a locked state, in a case where the door lock is switched from an unlocked state to the locked state when the vehicle is stopped, maintaining the lid lock in an unlocked state until the elapsed time reaches given determination time; and switching the lid lock to a locked state when the elapsed time reaches the given determination time.

A lock control system according to a third aspect of the present invention includes a lid lock that switches a lid of a vehicle, which is opened for refilling energy to the vehicle, to a locked state in which the lid is unable to be opened, and to an unlocked state in which the lid is able to be opened; a door lock control part that switches a door of the vehicle to a locked state in which the door is unable to be opened and closed, and to an unlocked state in which the door is able to be opened and closed; and a lid control part that is structured so as to measure elapsed time from a point when the door is switched by the door lock control part from the unlocked state to the locked state, control the lid lock so that the lid lock is in the unlocked state until the elapsed time reaches given determination time, and perform control to switch the lid lock to the locked state when the elapsed time reaches the given determination time.

According to the above aspect, even if the door lock is switched to the locked state, the lid lock is not switched to the locked state immediately. The lid lock is switched to the locked state after the determination time is elapsed from a point when the door lock is switched to the locked state. Therefore, if a user opens the lid before the lid lock is switched to the locked state, it is not necessary for the user to carry out an operation to switch the door lock into the unlocked state. Thus, it is possible to carry out necessary works for energy replenishment without impairing user convenience when replenishing energy.

In addition, according to this aspect, the determination time is changed based on the actual time from a point when the door lock is switched to the locked state to a point when the lid is opened. Therefore, since a trend of time that elapses before a user opens the lid is reflected to the determination time, the determination time may be changed to time that is appropriate for each user.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of a vehicle having a lock control system according to an embodiment of the present invention;

FIG. 2 is a flowchart for explaining a lock control method according to the embodiment of the present invention;

FIG. 3 is a time chart for explaining changes of a state of a door lock and a state of a charging inlet lid lock according to the embodiment of the present invention; and

FIG. 4 is a flowchart for explaining a lock control method according to a modified example of the embodiment of the present invention.

### DETAILED DESCRIPTION OF EMBODIMENTS

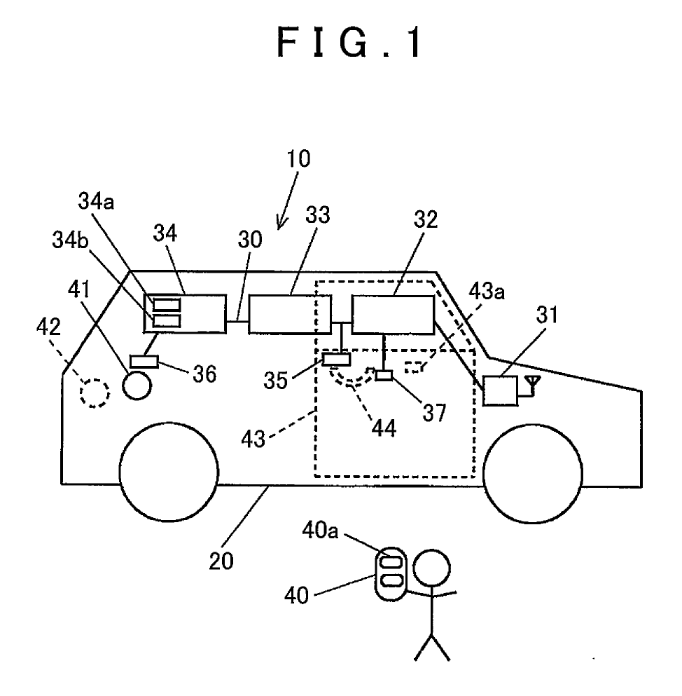

An embodiment will be explained in detail with reference to FIG. 1 to FIG. 3.

A vehicle 20 is, for example, a plug-in hybrid vehicle. In the vehicle 20, a communication device 31, a verification ECU 32, a body ECU 33, a charging ECU 34, a door lock 35, a charging inlet lid lock 36, a door lock sensor 37 and so on are connected with each other through an in-vehicle LAN 30. The communication device 31 wirelessly communicates with a portable device 40 (such as a smart key (registered trademark)) carried by a user such as a driver. In the vehicle 20, the body ECU 33 and the charging ECU 34 structure a lock control system 10 that controls the charging inlet lid lock 36.

On an out surface of the vehicle 20, a charging inlet lid 41 and a fuel lid 42 are provided. The fuel lid 42 is provided on a side surface of the vehicle 20 on the opposite side to the side of the charging inlet lid 41. The vehicle 20 may be an electric vehicle having the charging inlet lid 41 only.

The door lock 35 is structured so as to be switched by an actuator such as a door lock motor, between a locked state in which doors 43 of the vehicle 20 are unable to open, and an unlocked state in which the doors 43 are able to open. In the vehicle 20, the door lock 35 is provided for each of the plurality of doors 43 (for example, four doors). The door lock 35 is controlled by the body ECU 33 (a door lock control part). When a user carries out a door locking operation, the door lock 35 is switched from the unlocked state to the locked state on condition of permission from the verification ECU 32. When the user carries out the door unlocking operation, the door lock 35 is switched from the locked state to the unlocked state on condition of permission from the verification ECU 32.

The user is able to carry out the door locking operation or the door unlocking operation for the door 43 by operating a central door locking switch 43a provided on an inner side of the door 43 of a driver seat, and by operating a wireless door lock switch 40a provided in the portable device 40. The user is also able to carry out the locking operation or the unlocking operation for the door 43 by touching a door lock sensor 37 provided on an out surface of a door handle 44, and by touching a door unlock sensor (not shown) provided on an inner surface of the door handle 44. The door locking operation or the door unlocking operation is detected by the body ECU 33.

The charging inlet lid 41 is provided in a body of the vehicle 20 by, for example, a hinge mechanism, so that the charging inlet lid 41 is able to open and close. When the charging inlet lid 41 is open, the charging inlet lid 41 exposes a charging port, to which a connector of a charging plug is connected, and, when the charging inlet lid 41 is closed, the charging inlet lid 41 covers the charging port. When the charging inlet lid lock 36 is in an unlocked state, once a user presses the charging inlet lid 41, the charging inlet lid 41 opens. The fuel lid 42 is provided in the body of the vehicle 20 by, for example, a hinge mechanism, so that the fuel lid 42 is able to open and close. When the fuel lid 42 is open, the fuel lid 42 exposes an oil filler port, into which a fueling nozzle is inserted, and, when the fuel lid 42 is closed, the fuel lid 42 covers the oil filler port.

The charging inlet lid lock 36 is structured to be switched by an actuator such as a lid motor, between a locked state in which the charging inlet lid 41 is unable to open, and an unlocked state where the charging inlet lid 41 is able to open. The charging inlet lid lock 36 is switched between the locked state and the unlocked state by, for example, moving a lock pin forward and backward by using the actuator. The charging inlet lid lock 36 is controlled by the charging ECU 34 (a lid control part).

As the communication device 31 wirelessly communicates with the portable device 40 outside the vehicle 20, the verification ECU 32 permits the door lock 35 to lock or unlock the door 43. To be specific, when a door locking operation by a user is detected during a stopping period of the vehicle 20, the verification ECU 32 performs ID verification of the portable device 40 by wirelessly communicating with the portable device 40 through the communication device 31. When the ID verification of the portable device 40 is established, the verification ECU 32 permits the door lock 35 to lock the door 43, and outputs a door lock command to the body ECU 33. Meanwhile, when a door unlocking operation by a user is detected during a stopping period of the vehicle 20, the verification ECU 32 performs ID verification of the portable device 40 by wirelessly communicating with the portable device 40 through the communication device 31. When the ID verification of the portable device 40 is established, the verification ECU 32 permits the door lock 35 to unlock the door 43, and outputs a door unlock command to the body ECU 33.

The body ECU 33 controls the door lock 35 based on the door lock command or the door unlock command received from the verification ECU 32. The body ECU 33 receives the door lock command, the body ECU 33 switches the door lock 35 to the locked state. When the body ECU 33 receive the door unlock command, the body ECU 33 switches the door lock 35 to the unlocked state. When the door lock command is received, the body ECU 33 outputs a timer start command to the charging ECU 34. When the door unlock command is received, the body ECU 33 outputs a lid unlock command to the charging ECU 34.

The charging ECU 34 includes a timer 34a (a time measurement part) for measuring elapsed time from a point when the door lock 35 is switched to the locked state. When the charging ECU 34 receives the timer start command from the body ECU 33, the charging ECU 34 activates the timer 34a, and, at a time when measurement time t of the timer 34a reaches given determination time T (for example, thirty seconds), the charging ECU 34 switches the charging inlet lid lock 36 from the unlocked state to the locked state. On the other hand, when the charging ECU 34 receives the lid unlock command from the body ECU 33, the charging ECU 34 switches the charging inlet lid lock 36 from the locked state to the unlocked state at a point when the lid unlock command is received.

As stated above, the charging ECU 34 is structured so as to switch the charging inlet lid lock 36 in conjunction with switching of the door lock 35. However, when the door lock 35 is switched to the locked state, the charging ECU 34 does not switch the charging inlet lid lock 36 to the locked state immediately, but switches the charging inlet lid lock 36 to the locked state after maintaining the charging inlet lid lock 36 in the unlocked state until the measurement time t of the timer 34a reaches the determination time T.

### Operation of the Lock Control System

Next, a lock control method carried out by the lock control system 10 will be explained.

The explanation below will begin from a state where a user has performed the door unlocking operation for the door 43 of a driver's seat after the vehicle 20 is stopped, and then the user has opened the door 43 and disembarked. The charging inlet lid lock 36 is switched to the unlocked state at about the same time as the door lock 35 of the door 43 is switched to the unlocked state.

In step S101, the user performs the door locking operation for switching the door lock 35 to the locked state. The door locking operation is, for example, a user's act of touching a door lock sensor 37 of a door handle 44. Once the verification ECU 32 detects the door locking operation through the door lock sensor 37, the verification ECU 32 performs ID verification of the portable device 40 by wirelessly communicating with the portable device 40 through the communication device 31. In a case where the ID verification of the portable device 40 is established, the verification ECU 32 outputs the door lock command to the body ECU 33.

In step S102, the body ECU 33 that has received the door lock command controls the door lock 35 so that the door lock 35 is switched to the locked state. In addition, the body ECU 33 outputs the timer start command to the charging ECU 34. The charging ECU 34 that has received the timer start command activates the timer 34a so as to start time measurement by the timer 34a. In a case where the user carries out the door locking operation by pushing a wireless door lock switch 40a of the portable device 40, the verification ECU 32 detects the door locking operation through the communication device 31.

Next, in the step S103, the charging ECU 34 counts up the timer 34a. Then, in step S104, the charging ECU 34 performs a determination operation for determining whether or not the measurement time t of the timer 34a is shorter than determination time T (for example, T=thirty seconds). In the determination operation, in a case where the measurement time t of the timer 34a is shorter than the determination time T, the process returns to step S103. In the determination action, in a case where the measurement time t of the timer 34a is equal to or longer than the determination time T, the process moves to step S105. In step S105, the charging ECU 34 controls the charging inlet lid lock 36, and switches the charging inlet lid lock 36 to the locked state. Once step S105 is finished, the process of the flowchart ends.

In a case where the user opens the charging inlet lid 41 before the charging inlet lid lock 36 is switched to the locked state, in other words, before the measurement time t of the timer 34a reaches the determination time T, the charging ECU 34 stops and resets the timer 34a. In a case where, for example, the charging ECU 34 detects though a sensor and so on that the charging inlet lid 41 has been closed after the end of charging, the charging ECU 34 switches the charging inlet lid lock 36 to the locked state.

### Effects of the Embodiment

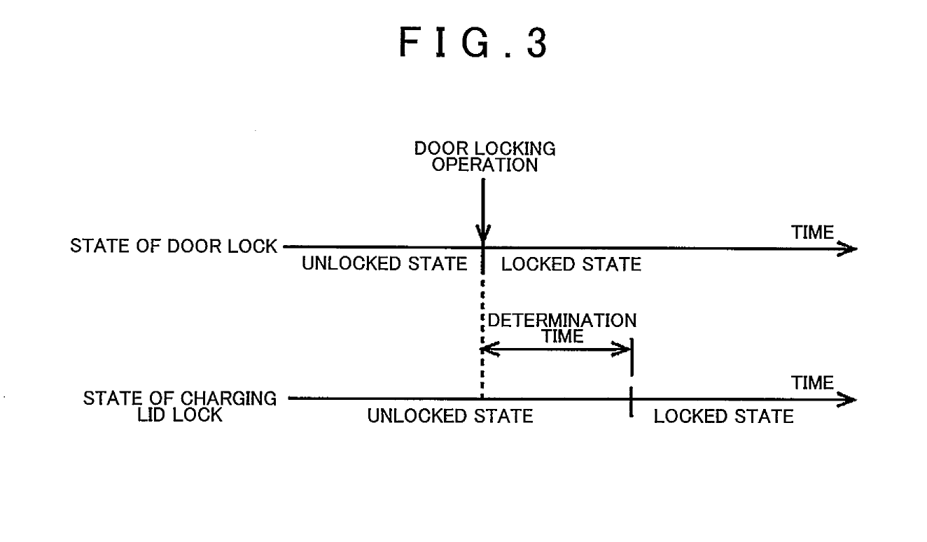

In this embodiment, as shown in FIG. 3, even if the door lock 35 is switched to the locked state, the charging inlet lid lock 36 is not switched to the locked state immediately. The charging inlet lid lock 36 is switched to the locked state after the determination time T is elapsed from a point where the door lock 35 is switched to the locked state. Therefore, if the user opens the charging inlet lid 41 before the charging inlet lid lock 36 is switched to the locked state, the user does not need to carry out the door unlocking operation. Hence, it is possible to conduct necessary works such as extending a charging cable and plugging a connector of a charging plug into a charging port, without impairing user convenience when charging the vehicle 20. Similarly to a case where a vehicle is not charged after disembarkation, a user is able to carry out the door locking operation immediately after disembarkation. This prevents the user from leaving the vehicle 20 without forgetting to carry out the door locking operation.

Further, in this embodiment, even in the case where the user does not charge the vehicle after disembarkation, the charging inlet lid lock 36 is automatically switched to the locked state once the measurement time of the timer 34a reaches the determination time T. Therefore, it is possible to prevent the charging inlet lid 41 from being opened by someone else, thereby preventing vandalization of the charging port and so on.

### Modified Examples of the Embodiment

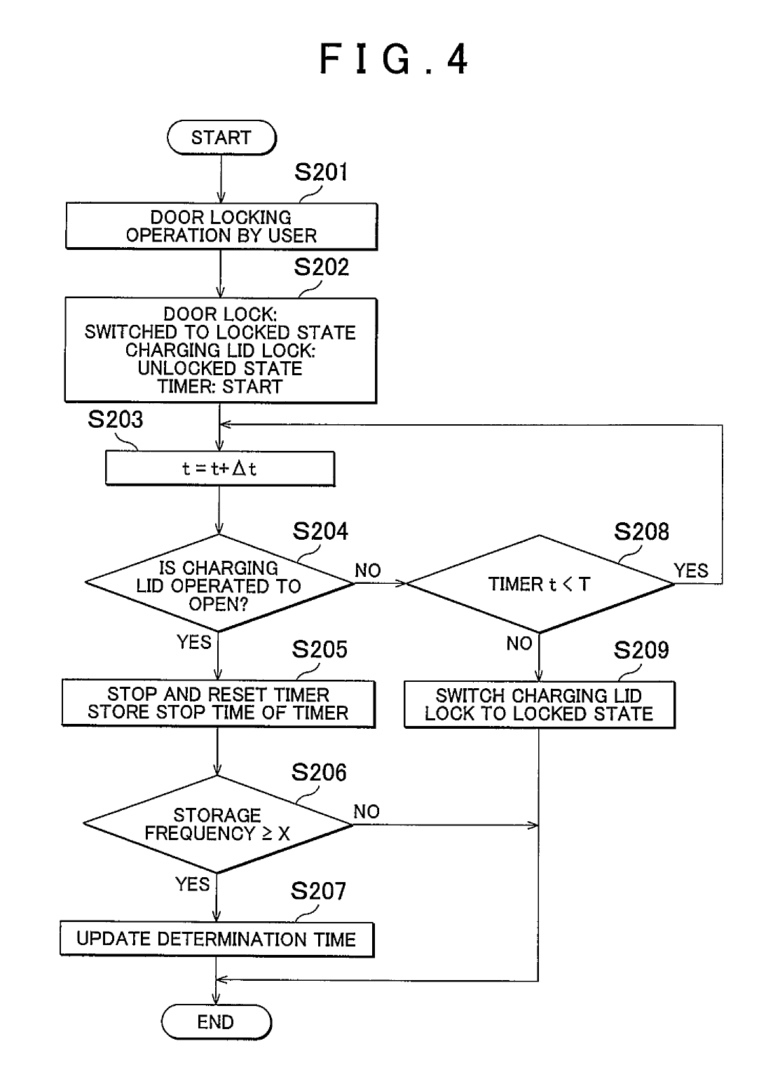

In this modified embodiment, determination time T is changed by learning control. In a case where a charging inlet lid 41 is opened before elapsed time reaches the determination time T, a charging ECU 34 stores actual time (in this modified example, stop time of a timer 34a) from a point when a door lock 35 is switched to a locked state to a point when the charging inlet lid 41 is opened, and the charging ECU 34 changes the determination time based on the actual time. FIG. 4 is a flowchart for explaining a lock control method according to the modified example of this embodiment.

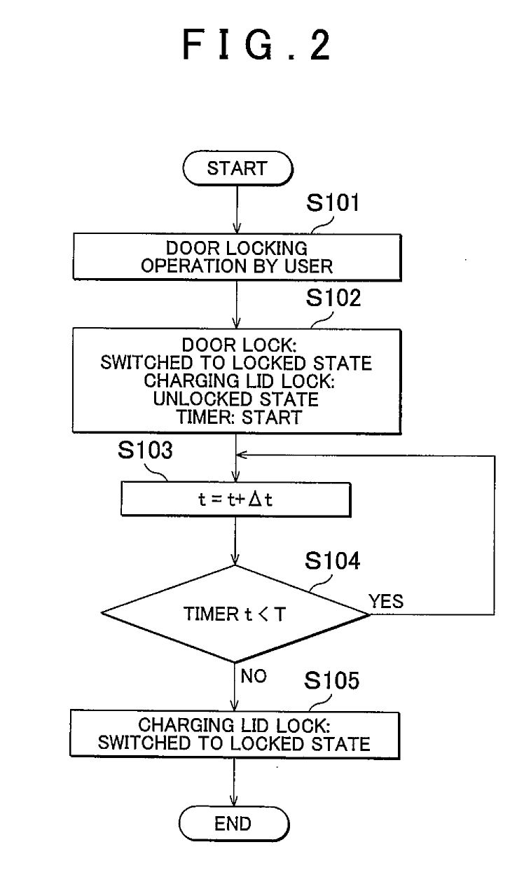

Similarly to the foregoing embodiment, the explanation below will begin from a state where a user has performed a door unlocking operation for a door 43 after a vehicle 20 is stopped, and then the user has opened the door 43 and disembarked. Step S201 is the same as step S101 in FIG. 2. Step S202 is the same as step S102 in FIG. 2. Step S203 is the same as step S103 in FIG. 2. Below is detailed explanation of step S204 and after.

In step S204, the charging ECU 34 determines whether or not a user has carried out an opening operation in order to the charging inlet lid 41, by using a sensor or the like provided in the charging inlet lid 41. When the opening operation by the user is detected, the charging ECU 34 moves to step S205. When the opening operation by the user is not detected, the charging ECU 34 moves to step S208.

In step S205, the charging ECU 34 stops and resets the timer 34a, and causes a memory 34b to store measurement time (stop time) at a point when the timer 34a is stopped. Next, in step S206, the charging ECU 34 determines whether or not the number of times that the stop time has been stored so far (storage frequency) in the memory 34b is a given set value X (for example, X=10) or larger. In a case where the storage frequency is equal to or larger than the set value X; the charging ECU 34 moves to step S207. In a case where the storage frequency is smaller than the set value X, the process of the flowchart is ended. In this case, the determination time T remains unchanged from a default value.

In step S207, the charging ECU 34 calculates an average value of the stop time that is most recently stored in the memory 34b for a given number of times (for example, ten times), and sets the average value as the determination time T. The determination time T is updated to the average value of the newest stop time stored for the given number of times, out of the stop time stored in the memory 34b. However, the method for calculating the determination time T is not limited to above. For example, the charging ECU 34 may set an average value of all stop time stored in the memory 34b as the determination time T. When the step S207 is finished, the process of the flowchart is ended.

In step S208, the charging ECU 34 performs a determination operation to determine whether or not the measurement time t of the timer 34a shorter than the determination time T (for example, T=thirty seconds). In a case where the determination time T has been updated, the updated determination time T is used. In the determination operation, in a case where the measurement time t of the timer 34a is smaller than the determination time T, the process moves back to step S203. In the determination operation, in a case where the measurement time t of the timer 34a is equal to or longer than the determination time T, the process moves to step S209. In step S209, the charging ECU 34 controls the charging inlet lid lock 36 to switch the charging inlet lid lock 36 to the locked state. When step S209 is finished, the process of the flowchart is ended.

When there is abnormal value that is sharply deviated from an average value (for example, a value that is larger than the average value by a given period of time (for example, three minutes) or longer), among the stop time stored for the given number of times and used for calculating an average value of stop time, it is possible to eliminate the abnormal value when calculating an average value of stop time. It is considered that stop time becomes an abnormal value when a user uses a charging station that is not normally used by the user, or a user, who is not familiar with a charging work, does a charging work. Thus, by eliminating an abnormal value from calculation of an average value of stop time, the updated determination time T is properly adjusted. In a case where stop time is an abnormal value, the charging ECU 34 does not have to cause the memory 34b to store the stop time in step S205. In the determination whether or not stop time is an abnormal value, the determination time T before update may be used as a reference. In this case, for example, stop time, which is longer than the determination time before update by a given period of time (for example, three minutes) or longer, is determined as an abnormal value.

Further, in this modified example, an average value of stop time is set as the determination time T as it is, among stop time stored in the memory 34b. However, a value obtained by adding a margin value (for example, ten seconds) to the average value may be set as the determination time T.

### Other Embodiments

The foregoing embodiment may also be structured as follows.

In the foregoing embodiment, the vehicle in which the lock control system 10 is installed is an engine automobile (for example, a gasoline automobile) having only the fuel lid 42 out of the charging inlet lid 41 and the fuel lid 42, or a hybrid automobile. In this case, in the case where the door lock 35 is switched to the unlocked state when the vehicle 20 is stopped, the lid control part switches the fuel lid lock to the unlock state in conjunction with the door lock 35. In the case where the door lock 35 is switched to the locked state when the vehicle 20 is stopped, the lid control part switches the fuel lid lock to the locked state after maintaining the fuel lid lock in the unlocked state until elapsed time, which is from a point when the door lock 35 was switched to the locked state, reaches the determination time T. In a case of a vehicle having both the charging inlet lid 41 and the fuel lid 42, this control may be applied to both the charging inlet lid lock 36 and the fuel lid lock.

In the foregoing embodiment, the charging inlet lid lock 36, is switched to the unlocked state at almost at about the same time as the door lock 35 of the door 43 is switched to the unlocked state. However, in the case where the door lock 35 is switched from the locked state to the unlocked state while the vehicle 20 is stopped, it is only necessary that the charging inlet lid lock 36 is switched from the locked state to the unlocked state in conjunction with the door lock 35, and switching of the charging inlet lid lock 36 to the unlocked state may be delayed from a point when the door lock 35 of the door 43 is switched to the unlocked state. This means that the expression of “switching the charging inlet lid lock 36 in conjunction with the door lock 35” includes not only a case where the charging inlet lid lock 36 is switched simultaneously (or almost simultaneously) with switching of the door lock 35, but also a case where switching of the charging inlet lid lock 36 is delayed by some time from a point when the door lock is switched. This also applies to the fuel lid 42 described above.

The present invention is applicable to a lock control system, a lock control method, and so on, which control a lid lock of a lid that is opened when replenishing energy in a vehicle.

What is claimed is:

1. A lock control device that controls a lid lock that locks a lid of a vehicle, the lid being opened when energy is replenished in the vehicle, the lock control device comprising:
a time measurement part that measures elapsed time from a point when a door lock of the vehicle is switched from an unlocked state to a locked state when the vehicle is stopped; and
a lid control part, which maintains the lid lock in an unlocked state until the elapsed time reaches determination time, and switches the lid lock to a locked state when the elapsed time reaches the determination time, in a case where the door lock is switched from the unlocked state to the locked state when the vehicle is stopped.

2. The lock control device according to claim 1, wherein
the lid control part stores actual time from a point when the door lock is switched to the locked state, to a point when the lid is opened, and changes the determination time based on the actual time, in a case where the lid is opened before the elapsed time reaches the determination time.

3. The lock control device according to claim 1, further comprising
a door lock control part that switches the door lock to the locked state, when an operation of a central door locking switch for switching all of the door locks into the locked state is detected, an operation of a wireless door lock switch for switching the door lock into the locked state using wireless communication is detected, or a contact by a user to a door lock sensor provided on the door is detected.

4. The lock control device according to claim 1, wherein,
the lid exposes a charging port to which a connector of a charging plug is connected when the lid is open, and covers the charging port when the lid is closed.

5. A lock control method for controlling a lid lock of a lid of a vehicle, the lid being opened when energy is replenished in the vehicle, the lock control method comprising:
measuring elapsed time from a point when a door lock of the vehicle is switched to a locked state, in a case where the door lock is switched from an unlocked state to the locked state when the vehicle is stopped;
maintaining the lid lock in an unlocked state until the elapsed time reaches given determination time; and
switching the lid lock to a locked state when the elapsed time reaches the given determination time.

6. The lock control method according to claim 5, further comprising
changing the determination time based on actual time that is from a point when the door lock is switched to the locked state, to a point when the lid is opened, in a case where the lid is opened before the elapsed time reaches the determination time.

7. The lock control method according to claim 5, further comprising
switching the door lock to the locked state, when an operation of a central door locking switch for switching all of the door locks into the locked state is detected, an operation of a wireless door lock switch for switching the door lock into the locked state using wireless communication is detected, or a contact by a user to a door lock sensor provided on the door is detected.

8. The lock control method according to claim 5, wherein,
the lid exposes a charging port to which a connector of a charging plug is connected when the lid is open, and covers the charging port when the lid is closed.

9. A lock control system comprising:
a lid lock that switches a lid of a vehicle, which is opened for refilling energy to the vehicle, to a locked state in which the lid is unable to be opened, and to an unlocked state in which the lid is able to be opened;
a door lock control part that switches a door of the vehicle to a locked state in which the door is unable to be opened and closed, and to an unlocked state in which the door is able to be opened and closed; and
a lid control part that is structured so as to measure elapsed time from a point when the door is switched by the door lock control part from the unlocked state to the locked state, control the lid lock so that the lid lock is in the unlocked state until the elapsed time reaches given determination time, and perform control to switch the lid lock to the locked state when the elapsed time reaches the given determination time.
